(19) United States
(12) Patent Application Publication
(10) Pub. No.: US 2020/0316717 A1
(43) Pub. Date: Oct. 8, 2020

(54) THREE-DIMENSIONAL PRINTING SYSTEM OPTIMIZING SEAMS BETWEEN ZONES FOR MULTIPLE ENERGY BEAMS

(71) Applicant: LAYERWISE NV, LEUVEN (BE)

(72) Inventors: Jan Plas, Wilsele (BE); Nachiketa Ray, Leuven (BE)

(21) Appl. No.: 16/830,971

(22) Filed: Mar. 26, 2020

(30) Foreign Application Priority Data
Apr. 8, 2019 (EP) 19167790

(51) Int. Cl. B23K 26/342; B33Y 10/00; B33Y 30/00; B33Y 50/02; B23K 26/06; B23K 26/08; B23K 26/10; B23K 26/14

(52) U.S. Cl. CPC B23K 26/342; B33Y 10/00; B33Y 30/00; B33Y 50/02; B23K 26/1464; B23K 26/0626; B23K 26/0876; B23K 26/10; B23K 26/0608

(57) ABSTRACT

A system for fabricating a three-dimensional article includes a powder dispenser and a fusing apparatus. The fusing apparatus is configured to generate and scan a plurality of beams across a build plane including a first beam and a second beam. The controller is configured to operate the powder dispenser and the fusing apparatus to form a sequence of at least three fused layers. The layers individually include a first hatch area defined by the first energy beam and a second hatch area defined by the second energy beam. The first and second hatch areas overlap along a seam with a transverse overlap distance. A lateral location of the seam varies layer by layer. No two layers in the sequence have a transverse distance between seams of less than u. The distance u is at least equal to twice the transverse overlap distance.

### CROSS-REFERENCE TO RELATED APPLICATIONS

This non-provisional patent application claims priority to European Patent Application Number EP 19167790, Entitled “THREE-DIMENSIONAL PRINTING SYSTEM OPTIMIZING SEAMS BETWEEN ZONES FOR MULTIPLE ENERGY BEAMS” by Jan Plas et al., filed on Apr. 8, 2019, incorporated herein by reference under the benefit of U.S.C. 119(e).

### FIELD OF THE INVENTION

The present disclosure concerns an apparatus and method for the fabrication of three dimensional (3D) articles utilizing powder materials. More particularly, the present disclosure concerns a manufacturing strategy that improves internal structural integrity of the articles when multiple energy beams are used.

### BACKGROUND

Three dimensional (3D) printing systems are in rapidly increasing use for purposes such as prototyping and manufacturing. One type of three dimensional printer utilizes a layer-by-layer process to form a three dimensional article of manufacture from powdered materials. Each layer of powdered material is selectively fused using an energy beam such as a laser, electron, or particle beam. Higher productivity printers can utilize multiple energy beams. One challenge with multiple energy beams is a transition from using one energy beam to another.

### BRIEF DESCRIPTION OF THE FIGURES

FIG. 1 is a schematic diagram of a three-dimensional printing system for fabricating a three-dimensional article.

FIG. 2 is a diagram illustrating a single layer of powder that has been selectively fused.

FIG. 3A is an illustration of a first layer of powder dispensed by a powder dispenser.

FIG. 3B is an illustration of a first layer of powder that has been selectively fused by two different energy beams.

FIG. 3C is an illustration of a second layer of powder that has been dispensed over a selectively fused first layer.

FIG. 3D is an illustration of a two layers of powder that have been selectively fused by two different energy beams.

FIG. 4 is an illustration of a sequence of powder layers that have been selectively fused. The layers have been individually fused with a first energy beam fusing a first area, a second energy beam fusing a second area, and a seam along which the first and second areas overlap. The seams are laterally offset from layer to layer with a minimum offset distance u and a lateral span of v. In the illustrated embodiment, there are five layers in a sequence.

FIG. 5 is an illustration of a sequence of powder layers that have been selectively fused. The layers have been individually fused with a first energy beam fusing a first area, a second energy beam fusing a second area, and a seam along which the first and second areas overlap. The seams are laterally offset from layer to layer with a minimum offset distance u and a lateral span of v. In the illustrated embodiment, there are two sequences of five layers each.

FIG. 6 is a diagram illustrating a lateral overlay view of a sequence of five fused layers.

FIG. 7 is a diagram of a selectively fused layer of powder in which two different energy beams are used to form inner contours.

### SUMMARY

In a first aspect of the invention, a system for fabricating a three-dimensional article includes a powder dispenser and a fusing apparatus. The fusing apparatus is configured to generate and scan a plurality of beams across a build plane including a first beam and a second beam. The controller is configured to operate the powder dispenser and the fusing apparatus to form a sequence of r selectively fused layers of powder in which r is at least 3. The layers individually include a composite hatch area, the composite hatch area includes a first hatch area defined by the first energy beam and a second hatch area defined by the second energy beam. The first and second hatch areas overlap along a seam with a transverse overlap distance (x). A lateral location of the seam varies layer by layer. For the sequence of r layers the seam varies in lateral location over a zone having a lateral width of v and in which no two layers in the sequence have a transverse distance between seams of less than u. The distance u is at least equal to two times the transverse overlap distance (x). The distance u can be at least equal to three times the transverse overlap distance (x). The distance v equals at least two times u.

In one implementation the plurality of beams includes a third beam. The controller is configured to operate the third beam to define at least part of a contour around the composite hatch area.

In another implementation the plurality of beams includes a third beam. The plurality of beams define a plurality of contours around the composite hatch area including an outer contour and an inner contour. The outer contour is formed by the third beam and the inner contour is formed by a combination of the first beam and the second beam. The outer contour can include a plurality of offset contours. The inner contour can include a plurality of offset contours.

In yet another implementation the transverse overlap distance (x) is based upon an alignment uncertainty of the first beam with respect to the second beam along a transverse axis that is transverse to the seam. The transverse overlap distance (x) is at least equal to the alignment uncertainty. The transverse overlap distance (x) can be at least equal to twice the alignment uncertainty, at least equal to three times the alignment uncertainty, or up to four times the alignment uncertainty.

In further implementations, r is at least 4, at least 5, or greater than 5. The transverse seam location can be varied randomly from layer to layer.

In a yet further implementation, the powder is a metal powder. The layers can be any practical thickness but a typical layer thickness is less than about 200 microns or less than about 150 microns. More particularly, a layer thickness can be in a range of 10 to 100 microns. Yet more particularly, a layer thickness can be in a range of 20 to 50 microns. The metal powder can be a pure metal such as titanium or an alloy. Alloys can be based upon aluminum, nickel, titanium, cobalt, iron, copper, and other metals. Some metal powders can be powder mixtures.

In another embodiment, v is at least three times u. In other embodiments, v is at least four times u, or at least five times u.

In a second aspect of the invention, a method for fabricating a three-dimensional article includes the following steps: (A) operating a powder dispenser to dispense a first layer of powder; (B) concurrently operating a plurality of energy beams including a first beam and a second beam to selectively fuse the layer of powder including (B1) operating the first beam to fuse a first hatch area and (B2) operating the second beam to fuse a second hatch area; the first and second hatch areas overlap along a first seam with a transverse overlap distance (x); (C) operating the powder dispenser to dispense a second layer of powder over the first layer of powder; (D) concurrently operating the plurality of energy beams to selectively fuse the second layer of powder including (D1) operating the first beam to fuse a third hatch area and (D2) operating the second beam to fuse a fourth hatch area; the third and fourth hatch areas overlap along a second seam; the second seam having an average transverse offset from the first seam by at least a value of u; (E) operating the powder dispenser to dispense a third layer of powder over the second layer of powder; (F) concurrently operating the plurality of energy beams to selectively fuse the third layer of powder including (F1) operating the first beam to fuse a fifth hatch area and operating the second beam to fuse a sixth hatch area; the fifth and sixth hatch areas overlap along a third seam; the third seam having an average transverse offset from the first seam and the second seam by at least a value of u; u is at least equal to two times the transverse overlap distance (x).

### DETAILED DESCRIPTION OF THE PREFERRED EMBODIMENTS

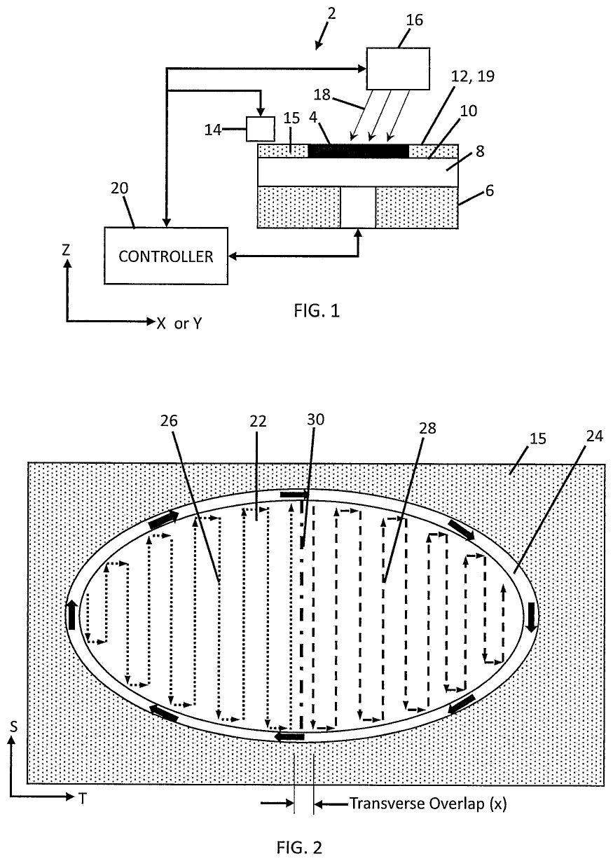

FIG. 1 is a schematic diagram of a three-dimensional printing system 2 for fabricating a three-dimensional article 4. In describing system 2, mutually orthogonal axes X, Y, and Z can be used. Axes X and Y are lateral axes and generally horizontal. Additionally, mutually orthogonal lateral axes S and T can be used. Axis S is used to describe a variable direction along a boundary such as a seam. The axis T is transverse to S. Axis Z is a vertical axis that is generally aligned with a gravitational reference. By “generally” we mean that a measure such as a quantity, a dimensional comparison, or an orientation comparison is by design and within manufacturing tolerances but as such may not be exact.

System 2 includes a build module 6 having a motorized platform 8. The motorized platform 8 has a support surface 10 upon which the three-dimensional article 4 is formed. The motorized platform 8 is configured to vertically position an upper surface 12 (either an upper surface of article 4 or surface 10) at an optimal height to allow a powder dispenser 14 to dispense a layer of powder 15 onto the upper surface 12. In an illustrative embodiment, the motorized platform 8 will be lowered before or after a layer of powder 15 is dispensed.

In an illustrative embodiment, the dispenser 14 dispenses layers of metal powder upon the motorized support 8. The layers can be any practical thickness but a typical layer thickness is less than about 200 microns or less than about 150 microns. More particularly, a layer thickness can be in a range of 10 to 100 microns. Yet more particularly, a layer thickness can be in a range of 20 to 50 microns. The metal powder can be a pure metal such as titanium or an alloy. Alloys can be based upon aluminum, nickel, titanium, cobalt, iron, copper, and other metals. Some metal powders can be powder mixtures of more than one pure metal, more than one alloy, or mixtures of alloys and pure metals. Yet other powders can include other materials such as ceramics.

A fusing apparatus 16 is configured to form and scan a plurality of energy beams 18 over the upper surface 12 of dispensed powder 15 to selectively fuse the powder 15. An energy beam 18 can be a high powered optical beam, a particle beam, or an electron beam. For a fusion of metal powder, a laser that outputs a beam having a power level of more than 100 watts is typical. Some lasers can output 500 watts, 1000 watts, or more than a kilowatt. The fusing apparatus 16 can include a laser, forming optics and scanning optics for forming and scanning the laser beam 18 over the surface 12.

In an embodiment, the plurality of energy beams 18 includes at least a first beam and a second beam. The plurality of energy beams can additionally include a third beam, or any number of beams. The plurality of energy beams 18 can individually be controlled and scanned independently and concurrently. The fusing apparatus 16 is configured to scan the energy beams over a laterally extending “build plane” 19 which is generally proximate to the upper surface 12 of the dispensed powder 15. The build plane 19 defines a lateral extent over which the plurality of energy beams 18 can address or operate upon. In a preferred embodiment, at least one of the energy beams 18 can address the entire build plane 19. In some embodiments, more than one energy beam 18 can individually address the entire build plane 19.

The plurality of energy beams have a lateral alignment uncertainty. This can be defined for two beams. When attempting to address the same position on the build plane with the two beams (defined by their centroids), there is a lateral alignment uncertainty of one beam with respect to the other. This uncertainty can vary due to variability of motion of the scanning mechanism along with other mechanical tolerances. The alignment uncertainty can be quantified with a standard deviation. The lateral alignment error can be defined as equal to two or more standard deviations. In one implementation, the alignment uncertainty can be defined as equal to three standard deviations. In a more conservative implementation, the alignment error can be defined as equal to four standard deviations.

The motorized platform 8, the powder dispenser 14, and the fusing apparatus 16 are all under control of a controller 20. The controller 20 includes a processor coupled to a computer-readable storage apparatus. The computer-readable storage apparatus includes a non-transitory or non-volatile storage medium that stores software instructions. When executed by the processor, the software instructions control various portions of system 2 including the motorized platform 8, the powder dispenser 14, and the fusing apparatus 16. The software instructions can also referred to as computer-readable code portions.

The controller 20 can be an integrated module or it can include a plurality of computers that are electrically or wirelessly coupled to one another. In a particular embodiment, the controller 20 includes a local controller that is physically integrated with other portions of system 2, a host computer, and a remote server. When the controller 20 is distributed among multiple computers, there can therefore be distributed processors and information storage devices that are accessed and utilized during the operation of the controller 20.

The controller 20 is generally configured to perform the following operations: (1) position the motorized support with an upper surface 12 proximate to the build plane 19, (2) operate dispenser 14 to dispense a layer of powder, (3) operate the plurality of lasers 18 to selectively fuse portions of the dispensed layer of powder, and (4) repeat (1)-(3) to complete fabrication of the three-dimensional article 4.

FIG. 2 illustrates an embodiment of a single layer of powder 15 that has been selectively fused. The selectively fused region includes a composite hatch pattern 22 surrounded by a contour 24. The composite hatch pattern 22 includes a first hatch pattern 26 and a second hatch pattern 28 joined by a seam 30. The first 26 and second 28 hatch patterns are individually formed by first and second lasers 18 respectively. The first 26 and second 28 hatch patterns are essentially contiguous at the seam 30. The hatch patterns 26 and 28 may overlap based upon an alignment uncertainty of the first and second lasers in a direction transverse to the seam 30. In the illustration, the seam 30 extends along axis S and a transverse axis T is perpendicular to the seam 30. For some geometries, the seam 30 may be nonlinear. Then, the direction S is defined as being tangential to the seam 30 and T is perpendicular to S.

In a typical embodiment, the first and second lasers have an alignment uncertainty with respect to each other along the transverse axis T. The first 26 and second 28 hatch patterns overlap along the transverse axis T with a transverse overlap distance (x). The transverse overlap distance (x) is at least equal to the alignment uncertainty. Preferably the transverse overlap distance (x) is at least two times the alignment uncertainty, three times the alignment uncertainty, or up to four times the alignment uncertainty.

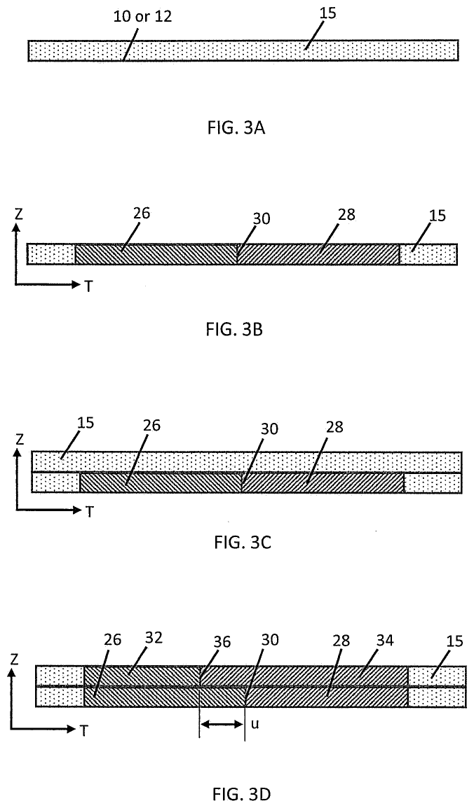

FIGS. 3A-D are illustrations depicting a deposition and fusion sequence of powder layers having a seam 30 having a transverse location that varies from layer to layer. The motorized platform 8, powder dispenser 14, and fusing apparatus 16 are operated by controller 20 to perform these steps.

According to FIG. 3A, dispenser 14 deposits a first layer of powder 15 on a surface 10 (or 12). According to FIG. 3B, first 26 and second 28 hatch patterns are fused by first and second energy beams 18 respectively. It is to be understood that the first 26 and second 28 hatch patterns overlap along the first seam 30 with a transverse overlap distance (x). The transverse overlap distance (x) along T is shown as a vertical line at seam 30 in FIG. 3B.

According to FIG. 3C, dispenser 14 dispenses a second layer of powder 15 over the first selectively fused layer. According to FIG. 3D, third 32 and fourth 34 hatch patterns are fused by the first and second energy beams 18 respectively. The third 32 and fourth 34 hatch patterns overlap along second seam 36 with a transverse overlap distance (x). Seams 30 and 36 are offset from each other by a minimum distance u.

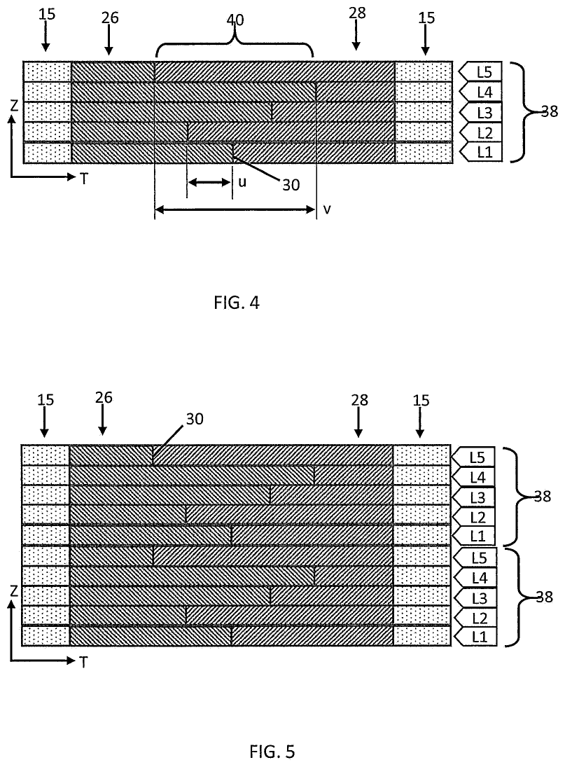

Powder dispensing and fusing can continue in a manner similar to the illustrate of FIGS. 3A-D until there is a sequence 38 of selectively fused layers as illustrated in FIG. 4. This is a sequence of five layers. The variable r will be defined as a number of layers in a sequence. For FIG. 4, r=5. The layers are designated L1-L5 in order of formation.

The seam 30 varies in lateral location from layer to layer along the transverse axis T. There is a minimum transverse lateral distance u between any two seams 30 within sequence 38. The seams 30 define a “seam zone” 40 having a width v which is the maximum transverse lateral distance between any two seams 30.

The width v is at least two times u. In various embodiments, v is at least 3 times, at least four times, at least five times, or more than five times u.

FIG. 5 depicts the sequence 38 for r=5 repeated twice. The sequence 30 can be repeated any number of times. More generally, sequences can have r values of three or more. Sequences for r=4, r=5, r>5, r>10 are possible. Also, the sequences 38 do not have to be exactly the same. For example, there could be a sequence with r=5 above a sequence for which r=10. In some embodiments, the seam locations along axis T can randomly vary from layer to layer with a limitation that any two layers in sequence have seams that are at least offset by some minimum transverse lateral distance u.

In some embodiments, an orientation of the seams can be rotated about the vertical axis Z from one sequence 38 to the next. This rotation can, in some embodiments, increase a strength of the article 4.

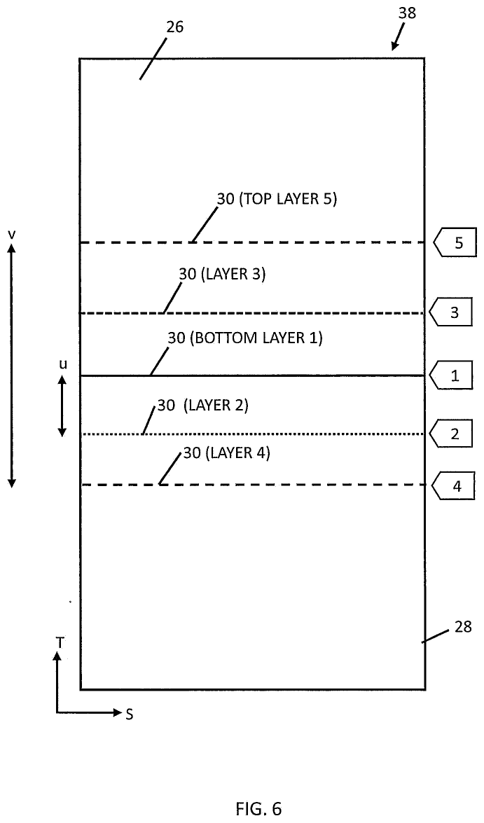

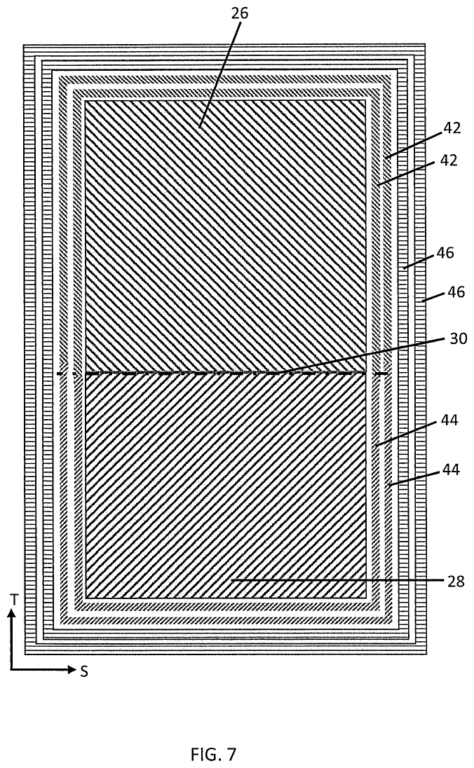

FIG. 6 is a diagram illustrating lateral overlay view of a sequence 38 of five fused layers (r=5). The upper portion of the diagram represents hatch area 26 formed by the first energy beam 18. The lower portion of the diagram represents hatch area 28 formed by the second energy beam 18. Hatch areas are separated by seams 30 that are labeled at the right of the diagram for layers 1 to 5. Thus, FIG. 6 is a lateral diagram for FIG. 4.

In typical embodiments, the hatch areas 26 and 28 overlap across the seams 30. The overlap is related to a transverse alignment uncertainty along the axis T of the first beam 18 with respect to the second beam 18. In one embodiment, the overlap along T at least equals the alignment uncertainty. The alignment uncertainty can be defined by three standard deviations of transverse alignment between the two beams.

The value of u is at least equal to two times the transverse overlap distance (x). In some embodiments, the value of u can be three times x or more than three times x.

FIG. 7 is a diagram of a selectively fused layer of powder. In this example, the concept of the seam 30 extends to contours. In the illustrated embodiment, a first energy beam 18 defines an upper hatch area 26 and upper and inner contours 42. A second energy beam defines a lower hatch area 28 and lower and inner contours 44. The inner contours 42 and 44 overlap along the seam 30. In some embodiments, the seam 30 may be discontinuous—that is, there may be a transverse offset between seams for the inner contours 42 and 44 and the hatch areas 26 and 28.

Surrounding the inner contours 42 and 44 are outer contours 46. Outer contours 46 are formed by a third energy beam 18. The number of inner and outer contours can be selected in part based upon an alignment uncertainty between the first and second energy beams.

The specific embodiments and applications thereof described above are for illustrative purposes only and do not preclude modifications and variations encompassed by the scope of the following claims.

1. A system for fabricating a three-dimensional article comprising:
a powder dispenser for sequentially dispensing individual layers of powder;
a fusing apparatus for generating and scanning a plurality of energy beams including a first beam and a second beam to selectively melt the layers of powder; and
a controller configured to:
operate the powder dispenser and the fusing apparatus to form a sequence of r selectively fused layers of powder in which r is at least 3, the layers individually including a composite hatch area, the composite hatch area includes a first hatch area defined by the first energy beam and a second hatch area defined by the second energy beam, the first and second hatch areas overlap along a seam with a transverse overlap distance (x), a lateral location of the seam varying by layer, for the sequence of r layers the seam varies in lateral location over a zone having a lateral width of v and in which no two layers in the sequence have a transverse distance between seams of less than u in which u is at least equal to two times the transverse overlap distance (x).

2. The system according to claim 1 wherein the plurality of beams include a third beam, the controller is configured to operate the third beam to define at least part of a contour around the composite hatch area.

3. The system according to claim 2 wherein the plurality of beams define a plurality of contours around the composite hatch area including an outer contour and an inner contour, the outer contour is formed by the third beam and the inner contour is formed by a combination of the first beam and the second beam.

4. The system according to claim 1 wherein the transverse overlap distance (x) is based upon an alignment uncertainty of the first beam with respect to the second beam along a transverse axis that is transverse to the seam, and wherein the transverse overlap distance (x) is preferably at least equal to the alignment uncertainty.

5. The system according to claim 1 wherein r is at least 5.

6. The system according claim 1 wherein the powder dispenser contains metal powder.

7. A method for fabricating a three-dimensional article comprising:
operating a powder dispenser to dispense a first layer of powder;
concurrently operating a plurality of energy beams including a first beam and a second beam to selectively fuse the layer of powder including:
operating the first beam to fuse a first hatch area; and
operating the second beam to fuse a second hatch area, the first and second hatch areas overlap along a first seam with a transverse overlap distance (x);
operating the powder dispenser to dispense a second layer of powder over the first layer of powder;
concurrently operating the plurality of energy beams to selectively fuse the second layer of powder including:
operating the first beam to fuse a third hatch area; and
operating the second beam to fuse a fourth hatch area, the third and fourth hatch areas overlap along a second seam, the second seam having an average transverse offset from the first seam by at least a value of u;
operating the powder dispenser to dispense a third layer of powder over the second layer of powder;
concurrently operating the plurality of energy beams to selectively fuse the third layer of powdering including:
operating the first beam to fuse a fifth hatch area; and
operating the second beam to fuse a sixth hatch area, the fifth and sixth hatch areas overlap along a third seam, the third seam having an average transverse offset from the first seam and the second seam by at least a value of u, u is at least equal to two times the transverse overlap distance (x).

8. The method according to claim 7 further comprising operating a third beam to fuse a contour around the first and second hatch areas.

9. The method according to claim 8 further comprising operating the first and second beams to define at least one inner contour around the first and second hatch areas and operating the third beam to define an outer contour around the inner contour.

10. The method according to claim 7 wherein the transverse overlap distance (x) is based upon an alignment uncertainty of the first beam with respect to the second beam, and wherein the transverse overlap distance (x) is preferably at least equal to the alignment uncertainty.

11. A computer-readable storage apparatus for fabricating a three-dimensional article, the computer-readable storage apparatus including a non-transitory storage medium storing software instructions, in response to execution by a processor the software instructions cause a system to:
operate a powder dispenser to dispense a first layer of powder;
operate a plurality of energy beams including a first beam and a second beam to selectively fuse the layer of powder including:
operate the first beam to fuse a first hatch area; and
operate the second beam to fuse a second hatch area, the first and second hatch areas overlap along a first seam with a transverse overlap distance (x);
operate the powder dispenser to dispense a second layer of powder over the first layer of powder;
concurrently operate the plurality of energy beams to selectively fuse the second layer of powder including:
operate the first beam to fuse a third hatch area; and
operate the second beam to fuse a fourth hatch area, the third and fourth hatch areas overlap along a second seam, the second seam having an average transverse offset from the first seam by at least a value of u;
operate the powder dispenser to dispense a third layer of powder over the second layer of powder;
concurrently operate the plurality of energy beams to selectively fuse the third layer of powdering including:
operate the first beam to fuse a fifth hatch area; and
operate the second beam to fuse a sixth hatch area, the fifth and sixth hatch areas overlap along a third seam, the third seam having an average transverse offset from the first seam and the second seam by at least a value of u, u is at least equal to two times the transverse overlap distance (x).

12. The computer-readable storage apparatus according to claim 11 wherein response to execution by a processor the software instructions cause a system to operate a third beam to fuse a contour around the first and second hatch areas.

13. The computer-readable storage apparatus according to claim 12 wherein response to execution by a processor the software instructions cause a system to operate the first and second beams to define at least one inner contour around the first and second hatch areas and operate the third beam to define an outer contour around the inner contour.

14. The computer-readable storage apparatus according to claim 11 wherein the transverse overlap distance (x) is based upon an alignment uncertainty of the first beam with respect to the second beam, wherein the transverse overlap distance (x) is preferably at least is equal to the alignment uncertainty.

15. The computer-readable storage apparatus of claim 13 wherein response to execution by a processor the software instructions cause a system to operate the first and second beams to define at least one inner contour around the first and second hatch areas and operate a third beam to define an outer contour around the inner contour.

16. The computer-readable storage apparatus of claim 13 wherein the transverse overlap distance (x) is based upon an alignment uncertainty of the first beam with respect to the second beam.

17. The computer-readable storage apparatus of claim 16 wherein the transverse overlap distance (x) is at least is equal to the alignment uncertainty.
